(19) United States
(12) Patent Application Publication
(10) Pub. No.: US 2003/0031993 A1
(43) Pub. Date: Feb. 13, 2003

(54) Medical examination teaching and measurement system

(76) Inventor: Carla Pugh, Redwood City, CA (US)

Correspondence Address: LUMEN INTELLECTUAL PROPERTY SERVICES, 45 CABOT AVENUE, SUITE 110, SANTA CLARA, CA, 95051, US

(21) Appl. No.: 10/192,756

(22) Filed: Jul. 9, 2002

Related U.S. Application Data
(63) Continuation-in-part of application No. 09/650,970, filed on Aug. 29, 2000, now Pat. No. 6,428,323.
(60) Provisional application No. 60/151,478, filed on Aug. 30, 1999.

(51) Int. Cl. G09B 23/28

(52) U.S. Cl. 434/262

(57) ABSTRACT

A system for teaching students to perform medical exams performed with direct manual contact with a body or organ surface. The system includes the following main parts: an anatomical simulator with a simulated surface, one or more sensors in the anatomical simulator, a feedback presentation unit in communication with the one or more sensors, and a software means to assess the performance of the user based on the sensor information. When manual contact is made with the simulated surface of the simulator, the one or more sensors generate signal(s) in response. Performance of the exam on the simulated surface generates a set of signals from the one or more sensors, which are processed by the data acquisition software and used by the feedback presentation unit to provide feedback for the exam.

### CROSS REFERENCE TO RELATED APPLICATIONS

This application is a continuation-in-part of application Ser. No. 09/650,970 filed on Aug. 29, 2000. application Ser. No. 09/650,970 filed on Aug. 29, 2000 is a based on and claims the benefit of U.S. Provisional Application No. 60/151,478 filed Aug. 30, 1999.

### FIELD OF INVENTION

This invention relates generally to a system and method for teaching students and health care professionals to perform medical examinations. More particularly, it relates to a system and method for teaching medical examinations performed using direct manual contact with a body or organ surface.

### BACKGROUND ART

Clinical physical examinations of the abdomen and soft tissues remain in the realm of skilled arts for medical professionals. Doctors spend years refining their examination and history taking techniques desiring to become skilled in an art which requires keen physical examination techniques and diagnostic discernment necessitating a heightened sense of awareness and clinical interpretation. While in early medicine a physician's physical examination skills were the primary and sometimes sole diagnostic modality, today many of these skills have fallen to the wayside in the midst of new and innovative radiographic and diagnostic technology. While these new technologies have been associated with a decrease in emphasis on physical examination skills, time has shown that physical examinations remain an extremely important diagnostic modality and are now more important in determining which or if additional diagnostic technologies are necessary especially in the interest of cost containment. Moreover, although the advancement of technology has brought forth various means of radiographic imaging to assist in making diagnoses, physical examination is still the most important diagnostic modality for several clinical situations. The patient with an acute abdomen must quickly be diagnosed and promptly taken to the operating room. Time wasted on radiographic imaging puts the patient at risk for complications or death. In addition, performance of the monthly self-breast examination is highly promoted by health care professionals and still remains a significant source of early detection of cancerous breast lesions. For these reasons and many others, there exists a need for consistent training of health care professionals (and laypersons where indicated) in making diagnoses using physical examination techniques which require direct human contact with a body or organ surface. In addition, there is also a need for objective assessment and individualized feedback on performance to ensure quality learning and obtainment of proficient examination skills.

### OBJECTS AND ADVANTAGES

Accordingly, it is a primary object of the present invention to provide a training system and method that provides immediate feedback to students performing a medical exam using direct manual contact with an organ or body surface such as the thyroid or an anatomical region such as the abdomen for example. The system provides for objective assessment and individualized feedback that instructors alone cannot give.

It is a further object of the invention to provide a measurement tool which captures the users' performance on a simulated medical examination. Performance data captured during simulated clinical examinations of an organ or body surface may be used to define reference examinations. Objective standards can be developed by using performance data from a pre-selected clinician group whose collective data quantitatively define how the “experts” perform certain examinations.

It is an additional object of the invention to provide a teaching system that measures a student's performance against newly established standards and provides a rating of the student's performance compared to a pre-selected group of clinicians, such as those with 20 or more years of experience for example. The desired result is more accurate performance assessments for health care professionals in training

It is another object of the invention to provide a system that simulates various environments in which an exam occurs, including an examination room or emergency room, and various types of patients, including a wide range of clinical conditions and demographics.

It is an additional object of the present invention to provide a system that interfaces with different feedback presentation units, some of which make the unit portable.

It is a further object of the present invention to provide a system that can be used for any type of medical examination performed manually using direct manual contact with an organ or body surface including anatomical regions such as the abdomen.

Finally, it is an object of the present invention to provide a system that is economical to construct, easy to transport and amenable to future technology developments such as virtual reality.

### SUMMARY

These objects and advantages are attained by a system for training a student to perform a medical exam performed manually using direct manual contact with an organ, body surface or an anatomical region such as the abdomen. When a student is examining a body surface, the instructor does not know how the student interprets or processes this information and can only reassure the student that what they are feeling is consistent with a certain diagnosis. In essence, the only way of knowing whether a student or clinician has learned to make a certain diagnosis is when they are directly responsible for assessing the patient. Unfortunately many patients suffer misdiagnoses while clinicians are still perfecting their skills. This invention will enable consistent training and assessment of doctors in training to ensure they have learned what their instructors intended. The system has four main parts: an anatomical simulator with a simulated surface, one or more sensors in the anatomical simulator, a feedback presentation unit in communication with the one or more sensor, and a software means to asses the performance of the user. When manual contact is made with the simulated surface of the simulator, the one or more sensors generate signal(s) in response. Performance of the exam on the simulated surface generates a set of signals from the sensor(s), which are processed by the data acquisition software and used by the feedback presentation unit to provide feedback for the exam.

Any exams requiring palpation or manual assessment of body or anatomical surfaces can be taught, such as abdominal exams, soft tissue exams, breast exams or organs including the spleen, the liver and intestines for example. The simulator and feedback are correlated with the exam; for example, the simulator is a manikin with an abdomen for teaching examination of the spleen through the abdominal wall as well as direct intra-operative assessment of the spleen once the abdomen has been opened. The simulator and feedback are also adjustable to select one of a number of predetermined exams.

Preferably, the simulator includes removable anatomical parts, for example, a normal spleen, an enlarged spleen or a liver with tumorous implants that are not visible on the surface or palpable through the abdominal wall. In some cases the surfaces of the individual organs may change the findings on abdominal wall palpation. In other cases, the abnormality in the organ can not be palpated through the abdominal wall but a radiograph shows the lesion which may be palpable once the abdomen is opened for surgical assessment and treatment. As some of the removable anatomical parts may represent a diseased condition, the exam is correlated with the diseased or normal condition. The student learns which exam or corrective procedure to perform by manually detecting an abnormal organ surface or soft tissue abnormality. The sensor(s) are preferably force sensing resistors, and the signals generated by the sensor(s) are representative of force(s) on the simulated body surface or organ.

The type of feedback provided varies with the feedback presentation unit. The feedback may be an indication of completion of the exam, defined by a set of predetermined steps; a graphical display of the exam results; instruction to the student; or a rating of the exam. In a preferred embodiment, the feedback presentation unit is a computer with a processor, display means, and converting means for converting or transforming the signals from the sensors into inputs for the computer. Computer readable code executable by the processor instructs the computer to process the inputs to provide immediate feedback to the student. For example, the code instructs the computer to compare the inputs with a reference exam, which varies with the diseased or normal condition, to derive a rating for the performance. The computer can also include storage means for storing video signals and associated audio signals representing a realistic patient environment and correlated with the reference exam and removable parts used during the exam. The computer readable code controls presentation of the video and audio signals, in addition to processing of the inputs. In alternative embodiments, the feedback presentation unit is a three dimensional virtual reality interface, a liquid crystal display (LCD) or an analog display.

The present invention provides a method for measuring and defining human performance. The sensors generate signals in response to contact with a body surface or organ and the signals are stored in data files. The data generated by human contact represents the performance of said user. Preferably the raw signals can be processed to generate quantitative descriptions of human performance. Performance characteristics of clinician cohorts can be determined and used as reference points for assessing other users. Preferably, experienced clinicians would perform simulated clinical examinations of simulated body surfaces or organs and their performances are captured. Raw signal data from several clinicians are then pooled and the commonalities in performance are used to define a reference examination by which students and other clinicians may be compared.

The present invention also provides an assessment tool or means that tests a clinician's decision making process. Before performing clinical examinations on the simulator, the student may receive a brief report on the patient's condition from a virtual colleague within the software program and then engage in a question and answer session with the virtual colleague and virtual patient. After performing a clinical examination on the simulator, the student will then make a decision to order labs and x-rays to assist in making a diagnosis and developing a treatment plan. Computer storage of the entire student-simulator interaction enables complete assessment of the student's cognitive and technical clinical skills.

Also provided by the present invention, is a method training a student to perform an exam performed manually on a body or organ surface. The method is preferably implemented by a computer and has the following steps: receiving signals from a tactile sensor in a simulator cavity of an anatomical simulator; and providing immediate feedback to the student. Signals are generated in response to a manual contact of the student with the simulated body or organ surface, and the feedback is in part derived from the signals. The feedback also depends on a predetermined exam type, such as an abdominal exam or soft tissue exam or palpation of the surface of an organ with variations of the exam type. Feedback includes a graphical display, a rating, or instruction to the student. The signals can be compared with a reference exam corresponding to a manually detectable and possibly pathological condition of the organ to derive the feedback. The signals can also be analyzed to determine whether a set of predetermined steps have been completed by the student, which is indicated to the student in the feedback. Video and audio signals representing a realistic patient environment can be presented to the student.

### BRIEF DESCRIPTION OF THE FIGURES

FIG. 1 shows a schematic diagram of one embodiment of the training system according to the present invention;

FIG. 2 shows a cross-sectional view of a simulated body surface of the system in FIG. 1, containing tactile sensors, and pathological growths within and beneath the surface according to the present invention;

FIG. 3 shows a front perspective view of a removable organ containing tactile sensors, used in the system of FIG. 1 according to the present invention;

FIG. 4 shows a schematic diagram of a preferred embodiment of the feedback presentation unit of the present invention, a computer system according to the present invention;

FIG. 5 shows a monitor display showing one embodiment of graphical feedback according to the present invention;

FIG. 6 shows a monitor display showing an alternative embodiment of graphical feedback according to the present invention;

FIG. 7 shows a monitor display showing video signals according to the present invention;

FIG. 8 shows a schematic view of a portable embodiment of the invention according to the present invention;

FIG. 9 shows a front perspective view of an LCD feedback presentation unit according to the present invention;

FIG. 10 shows a schematic view of a virtual reality embodiment according to the present invention;

FIGS. 11A-11D show block diagrams of alternative interactions among the student, simulator, and feedback presentation unit according to the present invention;

FIG. 12 illustrates abdominal palpation;

FIG. 13 illustrates breast palpation;

FIGS. 14a-c illustrate intra-abdominal palpation;

FIG. 15 illustrates transhiatal esophagectomy;

FIG. 16 illustrates dissection of an intramural esophageal tumor; and

FIG. 17 illustrates a pelvic extenteration.

### DETAILED DESCRIPTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

The present invention provides a system and method for teaching students and other health care trainees to conduct exams performed manually using direct manual contact with a body surface or an anatomical region such as the abdomen. As used herein, a body surface refers to any location on the body that is manually accessible and requires interpretation of the surfaces contacted and the structures beneath the surface to make a diagnosis. A commonality of all such exams or procedures is that they require physicians or practitioners to feel with their hand or hands, normal or pathologic conditions, on, within or beneath a body or organ surface. While the figures and description below refer mainly to abdominal and soft tissue exams, it is to be understood that all exams and procedures fitting this description are within the scope of the present invention. Furthermore, it will be apparent to one of average skill in the art how to modify the necessary details to apply the invention to any desired exam. Detailed examples of a variety of applicable procedures are given below. While the description below refers primarily to students, it is to be understood that the present invention can be used to train any current or future health care professionals such as medical students, nursing students, residents, or practicing physicians or other professionals. Furthermore, it can also be used by professionals who already know the exam or procedure but want to refresh or test their skills. Moreover, it can be used to help define, in quantitative terms, exactly what it is that the more experienced clinicians do when they perform clinical assessments of a given organ or anatomical surface.

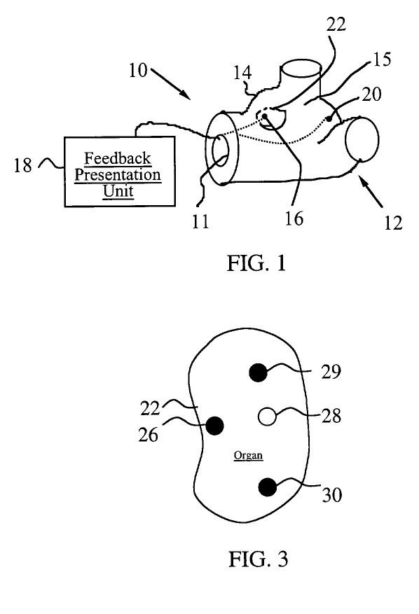

A teaching system 10 of the present invention, for training students to perform exams performed manually on a body or organ surface, is shown in FIG. 1. The system contains an anatomical simulator 12, in this case made from a manikin 14. Manikin 14 has a simulated cavity 11 and a simulated surface 15. Manikin 14 also has tactile sensors 16 and 20 located in cavity 11 and on surface 15, respectively, so as to generate a signal in response to manual contact with these locations. System 10 also contains a feedback presentation unit 18 in communication with sensors 16 and 20. As used herein, the feedback presentation unit provides any type of feedback, including visual, auditory, tactile, olfactory, or any combination of types. Signals generated by sensors 16 and 20 are transmitted to feedback presentation unit 18, which generates feedback based, in part, on the received signals. To perform the exam, the student places a hand on body surface 15. Palpation of this surface gives clinical information about body surface 15, as well as removable organ 22. In addition, if body surface 15 is surgically opened, to expose body cavity 11, organ 22 may be palpated directly. Sensors 16 and 20 generate a set of signals in response to the performance. Immediate feedback is provided to the student by feedback presentation unit 18.

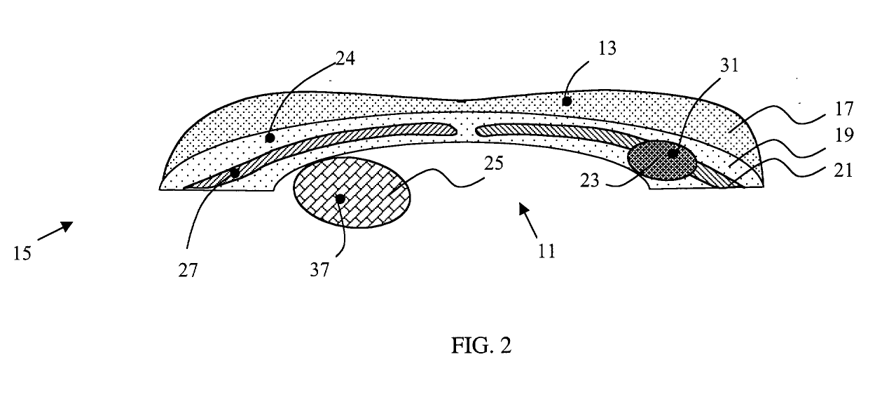

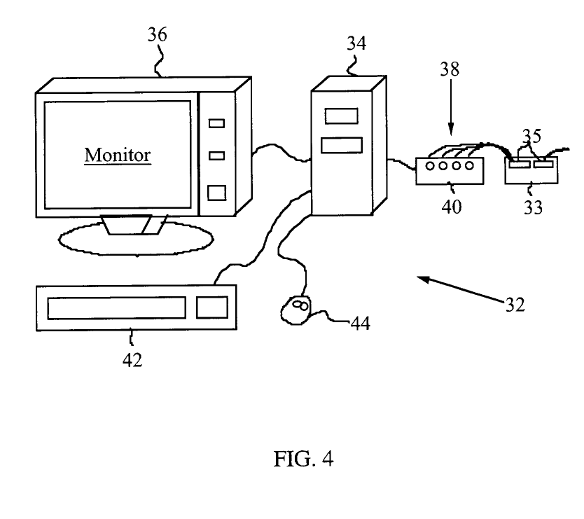

Simulator 12 is made from manikin 14 and sensors 16 and 20. In one embodiment, system 10 is used for teaching abdominal exams and manikin 14 is an anatomical model of the lower chest to mid thigh. Other anatomical models are used to teach different exams. Manikin 14 may have removable, interchangeable surfaces and organs. The abdominal wall may consist of several interchangeable tissue layers including skin, fat, connective tissue, muscle and bone. Any combination of these layers may be assembled to represent various clinical presentations, thus enabling an infinite number of simulated clinical examinations. For example, the manikin may be supplied with a few different interchangeable spleens, livers and abdominal wall layers, some of which are representative of diseased or abnormal conditions. In general, the interchangeable parts and tissue layers represent the expected human ranges of size, shape, and other qualities of normal and pathological organs and tissue layers. FIG. 2 shows an exemplary body surface 15 for use with simulator 12. Body surface 15 has layers, 17, 19 and 21, as well as pathologic lesion 23. Body surface lesion 23 is embedded in layers 19 and 21, while an additional lesion 25 is beneath body surface 15 and within body cavity 11. FIG. 3 shows and exemplary removable organ, a spleen 22 for use in simulator 12.

Alternatively, the simulator may be a simple mass that can conform to many cases. Miniature robots inside the cavity can be used to haptically mimic a variety of scenarios. For example, the same mass can be used to simulate an arm with a lipomatous growth or an enlarged spleen or a liver with tumorous implants, depending upon the response of the robots. The simulator may also be any type of surface on which manual exams are performed, not necessarily medical exams.

For the present invention, manikin 14 is modified by adding at least one tactile sensor 20. Preferably, the sensor is a force sensing resistor that generates a signal representative of the amount of force applied to the sensor. The sensor is placed within manikin 14 so that the force it detects is related to the force on surface 15. The sensor can also be a fiber optic light source or motion detector. Moreover, force feedback sensors or miniature robotic equipment that applies a force in response to detecting a force, may also be used. Sensors are placed in any location on or within the manikin necessary to gather information indicative of the quality of the exam performance. In FIG. 2, five discrete sensors 13, 24, 27, 31 and 37 are placed in relation to body surface 15 within layers 17, 19, and 21 and on pathologic lesions 23 and 25 respectively.

Similarly, in FIG. 3, four discrete sensors 26, 28, 29, and 30 are placed within the organ or anatomical part, one each at the anterior 26 and posterior 28 sides and, superior 29 and inferior 30 poles.

Any variations in the location and type of sensors are within the scope of the present invention. Preferably, the sensors are placed within the body and organ surface layers, so that they are not rubbed off or moved by repeated student contact. Alternatively, the sensors can be secured directly to the body surface or the organs. Each interchangeable part can have its own set of attached sensors. Sensors can also be placed on the interior wall of the cavity, or on any location within the cavity. When diseased organs are used, sensors are placed such that detection of the diseased condition requires palpation of the region detected by the sensor. Note that sensors are not necessarily placed on the areas that are palpated. Rather than detecting student hand pressure directly, sensors in various locations can detect forces from adjacent regions caused by palpation. This adjacent region may be a different surface (e.g. posterior abdominal wall) that is either within or outside the cavity containing the organ or connected to it by another organ directly or indirectly accessible to the student. For example, palpation of the spleen may cause indirect pressure on the pancreas or posterior abdominal wall. Sensors in these locations may give more detailed information about the characteristics and quality of an examiner's palpation techniques.

Tactile sensor technology is developing rapidly, particularly in the field of fiber optics and virtual reality. It is anticipated that newly developed sensors will expand the capabilities of the present invention. For example, instead of point sensors, a distributed sensor may be used. A distributed sensor can be placed in a sheet around the spleen, for example, and track pressure and location along the sheet. In fact, a particularly advantageous embodiment of the present invention has a distributed tactile sensor placed so that all manual contact (with one or both hands) a student makes with the cavity is detected by the sensor. A much fuller evaluation of the student's performance can be made with such a sensor. In another embodiment, the entire organ or surface may be made using solid materials with sensing capabilities similar to those materials with fiber optics embedded within.

The optimal number, location, and type of sensors vary with the pathological or normal condition represented by the cavity or organs and with the desired fidelity. For example, detection of an abnormal condition in one region of an organ or simulated body surface may require palpation of a second region that is not palpated under normal conditions. The second region contains a sensor only when the exam tests detection of abnormal conditions. A high fidelity exam in general contains more sensors to generate a more accurate representation of the exam being performed. A low fidelity exam contains fewer sensors and therefore generates a more limited reproduction of the exam. The number, type, and location of the sensor or sensors in general affect other parts of the system, such as the feedback presentation unit.

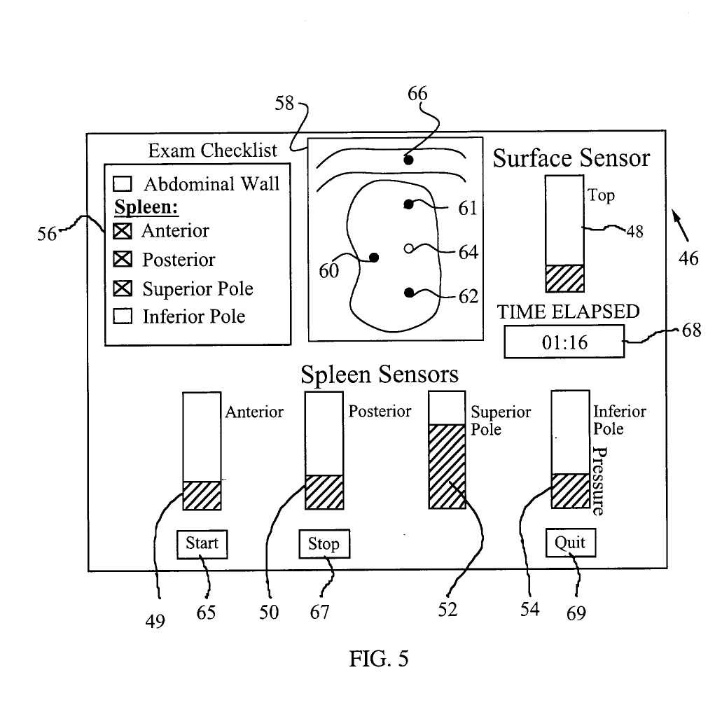

FIG. 4 shows a currently preferred embodiment of feedback presentation unit 18, a computer system 32 containing a computer 34; input and output devices such as a display means or monitor 36, keyboard 42, or mouse 44; and an interface 38 for interfacing sensor 16 with computer 34. Computer 34 contains standard elements such as a processor, data bus, various memories, and data storage devices. Interface 38 contains lines and converting means for converting the set of signals from sensor 16 into inputs for computer 34. For some sensors, analog voltage signals from the sensor must be converted into digital inputs to the computer using standard hardware and methods known in the art. For example, sensor 16 is connected to quad op-amplifiers 35 on a bread board 33 by twisted wire. Bread board 33 is also connected to an in-and-out connector block 40, which is connected through a serial port of computer 34 to a data acquisition card (not shown) within computer 34. While FIG. 4 illustrates a typical computer system, other embodiments are possible. For example, interface 38 may instead by implemented with wireless devices. Alternatively, the entire computer system and sensor are contained within a single small unit within simulator 12, and the feedback, e.g., auditory feedback, is provided directly from the small unit.

The objective of the feedback provided by the feedback presentation unit is to train the student to recognize characteristics of the simulated body or organ surface by touch alone. Viewing real-time feedback and receiving instructor guidance based on that feedback together allow the student to determine what he or she should be feeling, and then internalize that knowledge. Accordingly, the feedback presentation unit provides any type of feedback, including positive, negative, or summative, that attains the above objective. Feedback can be provided in visual, auditory, tactile, or olfactory format, or any combination of these. In the embodiment of FIG. 4, computer readable code stored within memory and executed by the computer's processor instructs the computer to process the inputs originating from the sensor or sensors to create feedback for the student and instructor. In general, the type of feedback and manner in which it is conveyed to the student are tailored to the educational objectives, type of exam, and ability and experience level of the student, among other factors. Preferably, a single system contains a number of possible variations of the feedback, selectable by the student or instructor. Upon reading this description, one of average skill in the art will be able to write appropriate computer readable code to implement the various embodiments of the present invention.

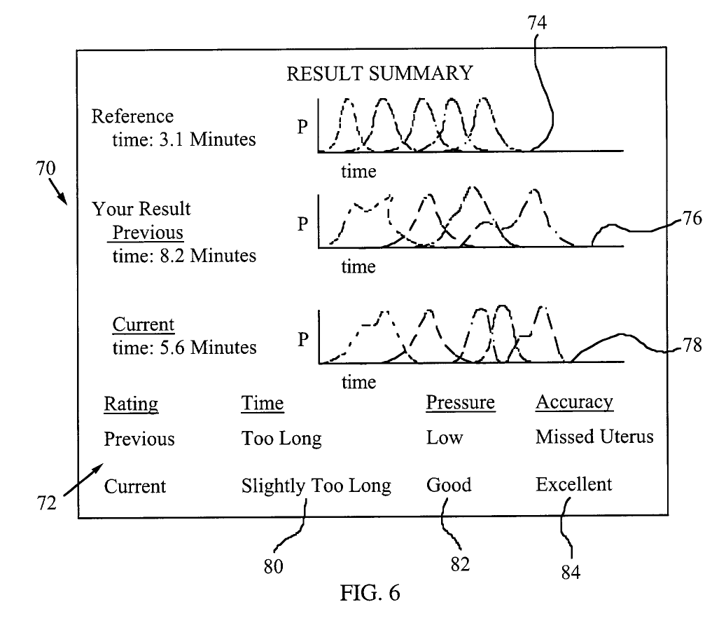

One embodiment of the feedback is a real-time graphical display of the sensor inputs. FIG. 5 shows a monitor display of graphical feedback 46 that provides instantaneous pressure readings from the sensors. Feedback 46 is purely illustrative of one type of feedback, and in no way limits the scope of the present invention. In the exam that produces the display of FIG. 5, the student must palpate five specific regions with a minimum pressure. The five regions include the anterior, posterior, superior and inferior surfaces of the spleen, and the simulated body surface. The display of FIG. 5 contains bars 48, 49, 50, 52, and 54, one for each palpation region, an exam checklist 56, and an illustration 58 with indicators 60, 61, 62, 64, and 66. Illustration 58 represents the spleen 22 and body surface 15 of FIGS. 2 and 3, with associated sensors. Graphical feedback 46 also includes an elapsed time 68, and “Start,” “Stop,” and “Quit” buttons 65, 67, 69 that can be clicked with a mouse pointer or other input device. As pressure is applied to each of the sensors by the student, the appropriate bar is filled in, with the filled volume proportional to the applied pressure. The scale of bars 48, 49, 50, 52, and 54 is set either in the computer readable code or via user input. When the student palpates the superior pole of the spleen with a minimum required pressure, bar 52 fills and indicator 61 turns on. In checklist 56, the box beside spleen “superior pole” is checked. When the student releases pressure, bar 52 is less filled, and indicator 60 is deactivated. However, the box beside “superior pole” remains checked to indicate exam progress. The same interface may be used when palpating the spleen through the abdominal wall or directly, once the abdomen has been entered. The approach to the spleen determines which splenic sensors the user will have access to. Illustration 58 is highly schematic in FIG. 5, but it may be replaced by a detailed illustration of the patient's interior and exterior landscape and location of the student's hand. Elapsed time 68 stops either when the student palpates all of the required areas, or when the user clicks “Stop” button 67. Similarly, the student begins the exam by clicking “Start” button 65.

Within the computer readable code, the instructor sets the minimum required pressure and a range of prescribed pressures. Alternatively, when the code is first executed, the computer requests pressure information from the instructor. Appropriate pressures vary with the patient's clinical condition, student's hand size or expertise, and other variables. Many other relevant graphical displays can be imagined, depending on the type and distribution of sensors, exam type, student experience, and other factors. For example, the graphical display can include a map corresponding to the pattern of pressure applied. The graphical display can be implemented using standard techniques, programming languages, and commercial software development tools, as apparent to one of average skill in the art.

System 10, incorporating the graphical display embodiment of FIG. 5, is designed for use by a student and instructor together. Standard operation proceeds as follows. First, the instructor performs the exam while the student watches graphical display 46 and notices the appropriate palpation pressure and duration and exam timing. Next, the student performs the exam while the instructor watches graphical display 46 and gives feedback to the student. The student integrates tactile information with visual feedback from the graphical interface and verbal feedback from the instructor to gain a better understanding of proper exam technique.

In an alternative embodiment of the computer readable code, the computer memory contains a stored reference exam. The reference exam consists of pressure versus time data for each sensor, and may be obtained from an average of exams performed by a professor, clinician, or other expert. For a distributed sensor, the stored exam also contains location data. There may be multiple stored reference exams, each associated with a diseased condition of a removable part of the simulator or other condition. During the exam performance, inputs are stored as pressure versus time data for each sensor. The student data is compared with the stored reference exam to derive a rating for the exam or to give instruction during the exam. The rating can be based on coverage, pressure levels, duration of pressure at a given location, overall exam time, or any other suitable measure. In this embodiment, the simulator may be used as a self-learning tool and the instructor need not be present while the student is performing the exam.

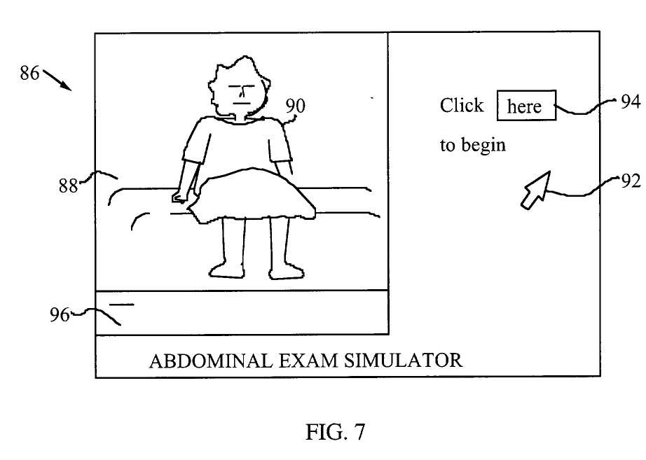

FIG. 6 shows a monitor display 70 of possible performance ratings. Display 70 is purely illustrative of a ratings display, and in no way limits the scope of the present invention. Monitor display 70 appears after the student completes an exam performance. The reference exam is displayed in a reference exam graph 74, which displays pressure versus time for each of the four sensors. Of course, reference exam graph 74 depends on the number and type of sensors used. Also displayed are previous performance graph 76 and current performance graph 78. Previous results for the same student may be stored in a data storage device and displayed to demonstrate the student's progress. Also displayed are qualitative ratings 72 for the performance: a time rating 80, a pressure rating 82, and an accuracy rating 84. Any suitable ratings system may be developed for the present invention, including quantitative ratings systems.

In a further alternative embodiment, the feedback is instruction, preferably audio instruction, provided to the student during the performance. For example, if the computer input indicates that the pressure is below the reference exam pressure at a given location, but above the background pressure, the computer readable code directs play of an audio file that says “press a little harder.” This embodiment can be used by a student alone or with a student partner; an instructor is not required.

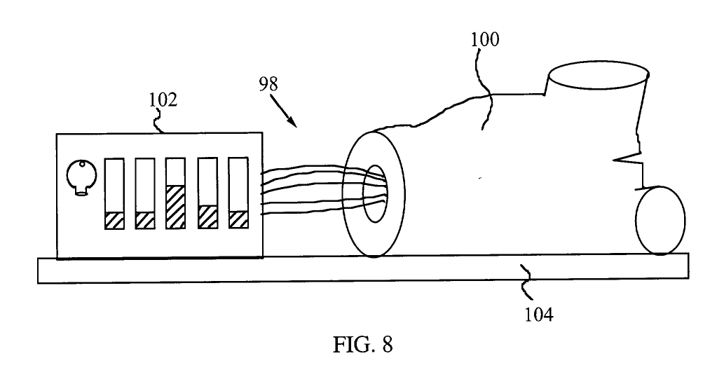

The computer system can also contain storage means for storing video signals and associated audio signals representing a realistic patient environment. Preferably, the audio and video signals are located in files stored in the memory or storage device of the computer. The computer readable code controls presentation of the files to the student. FIG. 7 shows a monitor display 86 containing a video signal 88. Display 86 is purely illustrative of video displays and does not limit the scope of the present invention. Video signal 88 is of a patient 90 on whom the student will perform a pelvic exam. Patient 90 in video signal 88 can be in any suitable environment in which the exam is performed, such as an emergency room, examination room, delivery suite, or other clinical setting, and can be a new healthy or diseased patient or a follow-up patient. Based on the patient's requests and other information conveyed in video signal 88 and associated audio signals, the student determines the appropriate exam to perform. To begin playing the video signal, the student uses mouse 44 to direct cursor arrow 92 to button 94 and clicks the mouse button. In box 96, the student can type a message to patient 90 in response to audio signals associated with video signal 88. The reference exam used to rate the student's performance is correlated with video signal 88. The exam rating may include an evaluation of the student's input in box 96. For example, the student must properly introduce him- or herself to the patient before beginning the exam.

Preferably, the computer system maintains a database of exams and cases that can be regularly updated by a user. For example, a senior resident performs a patient exam and records a video of the patient and procedure. She then devises a reference exam case containing the procedure she performed, her diagnosis, and a recommended treatment. The case along with the associated video is incorporated into the database and used to train a junior resident. The junior resident views the video and performs an exam on the simulator to determine whether he arrives at the same diagnosis and treatment recommendation as the senior resident.

In addition to providing feedback to the student and instructor during performance of the exam, the computer can also store student performance data and ratings. Later, the instructor can examine the data of students that did not perform adequately to determine which part of the exam or technique the student is having difficulty learning. The instructor can then tailor instruction to address the student's deficiencies. Students may also assess their own performance and practice on certain areas before seeking the advice of an instructor.

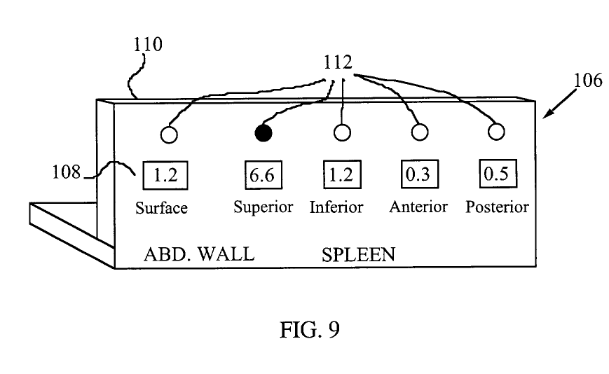

The present invention may be made portable and inexpensive through the use of alternative feedback presentation units. FIG. 8 shows a portable training system 98 in which a simulator 100 containing sensors is connected with a display screen 102. Both are mounted on support 104. Presentation unit 102 is simple and lightweight and provides a graphical display of the pressures exerted by a student. Presentation unit 102 contains simplified processing means specifically for processing inputs from the sensors.

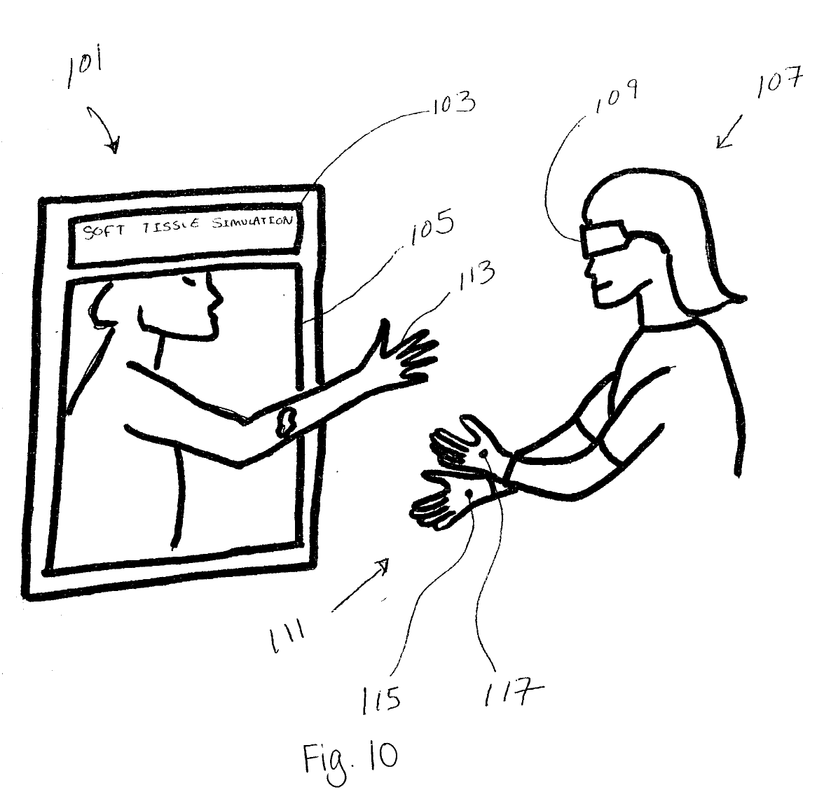

An additional alternative feedback presentation unit, an LCD (liquid crystal display) display unit 106, is shown in FIG. 9. Inputs to the unit are displayed as digital pressure readings 108. Also contained on a base 110 are light sources 112 that generate light when the pressure exceeds a minimum. It is well known in the art how to translate voltage signals into accurate LCD displays.

Moreover, the system of the present invention can be adapted for use in training facilities without access to computers or even basic electronics, for example, in developing nations. Rather than electronic sensors that produce voltage signals, the sensors may be fluid-filled sacs placed at desired locations on the manikin. In this case, the feedback presentation unit is a set of manometers, interfaced to the sensors by plastic tubing. Because of the low pressures required, water manometers made from thin glass tubing would be suitable.

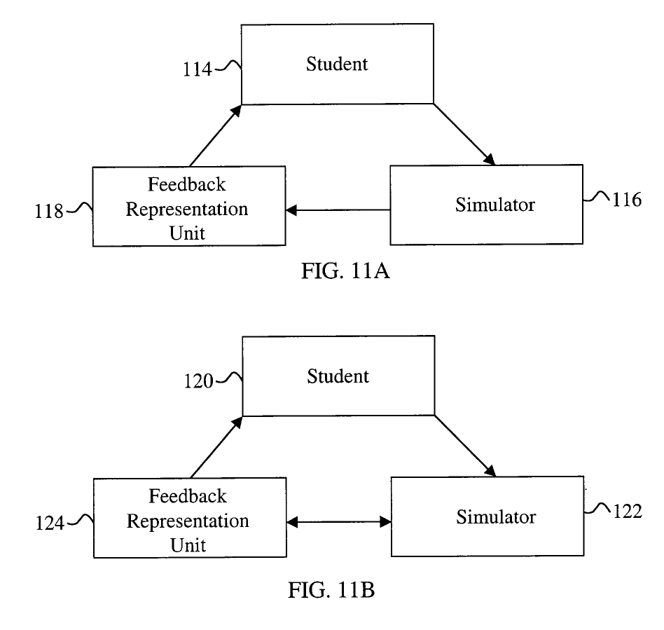

The system of the present invention may also be used with advanced imaging and haptics based technologies to create a virtual training system, combining the use of three-dimensional images with sensing and force feedback technology, FIG. 10. In this embodiment there is no physical model or manikin, but the simulator and feedback presentation unit are combined within one three-dimensional display system 101. The three-dimensional display system 101 may have means for both a monitor display 103 and a simulator display 105. Alternatively, there may be several types of feedback provided from the monitor, many of which have already been described in previous sections. In addition, the simulator display may take on all the various shapes, forms, layers and other presentations described in previous sections thus enabling an infinite number of simulated clinical conditions to be presented. To interact with the system, user 107 will possess a pair of three-dimensional glasses 109 and virtual-reality or haptic feedback gloves 111. User 107 can see, feel and palpate simulated body part 113 by interacting with simulator display 105. Sensors 115 and 117 record the user's exam performance. FIG. 10 is a highly diagrammatical representation of a preferred virtual reality application of the present invention and does not in any way limit use of the present invention as future virtual reality technology is developed.

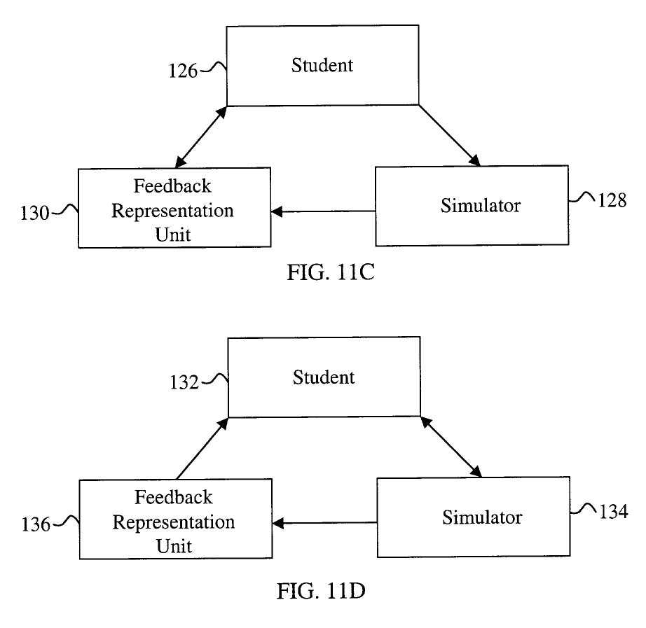

A general embodiment of the training system described above is depicted schematically in FIG. 11A. A student 114 contacts a simulator 116, and the sensor within the simulator transfers information to a feedback presentation unit 118. Feedback presentation unit 118 provides feedback to student 114, causing student 114 to modify the contact with simulator 116. FIG. 11B depicts an alternative embodiment. Again, a student 120 contacts a simulator 122 containing a sensor that generates a signal. The signal is transferred to a feedback presentation unit 124. In addition, feedback presentation unit 124 includes a controller for adjusting the behavior or structure of simulator 122, according to either a preset program or in response to contact supplied by student 120. The student perceives this change and adjusts the contact accordingly. A third embodiment is shown schematically in FIG. 11C. The initial three interactions among a student 126, a simulator 128, and a feedback presentation unit 130 still exist. Now, student 126 must also interact directly with feedback presentation unit 130, either by answering questions posed or by describing information gathered through contact with simulator 128. For example, a diseased patient may require further medical treatment. Based on the exam results the student inputs treatment recommendations into the computer. Student inputs can be through any input device, such as a keyboard, mouse, joystick, pen, microphone and speech-recognition element, or some combination of these devices. Finally, FIG. 11D illustrates a fourth embodiment, the so-called virtual reality embodiment, which still contains the original three interactions among a student 132, a simulator 134, and a feedback presentation unit 136. In this embodiment, simulator 134 is not an anatomical manikin, but a robot or virtual reality (VR) glove that responds to the student's hand movements by applying a force to the student's hand. For example, the student watches an image of a patient that is correlated with the movement of the VR glove. Only the portion of the student's hand remaining outside the patient body is visible. As the student performs the exam, the glove provides tactile feedback corresponding to the inner surface of the body cavity, simulating the feeling a student would have performing the exam on a live patient. The moving glove is in some ways more representative of a live patient than is a manikin. Combinations of the above four embodiments will be obvious to one skilled in the art upon reading this description, and are therefore within the scope of the present invention.

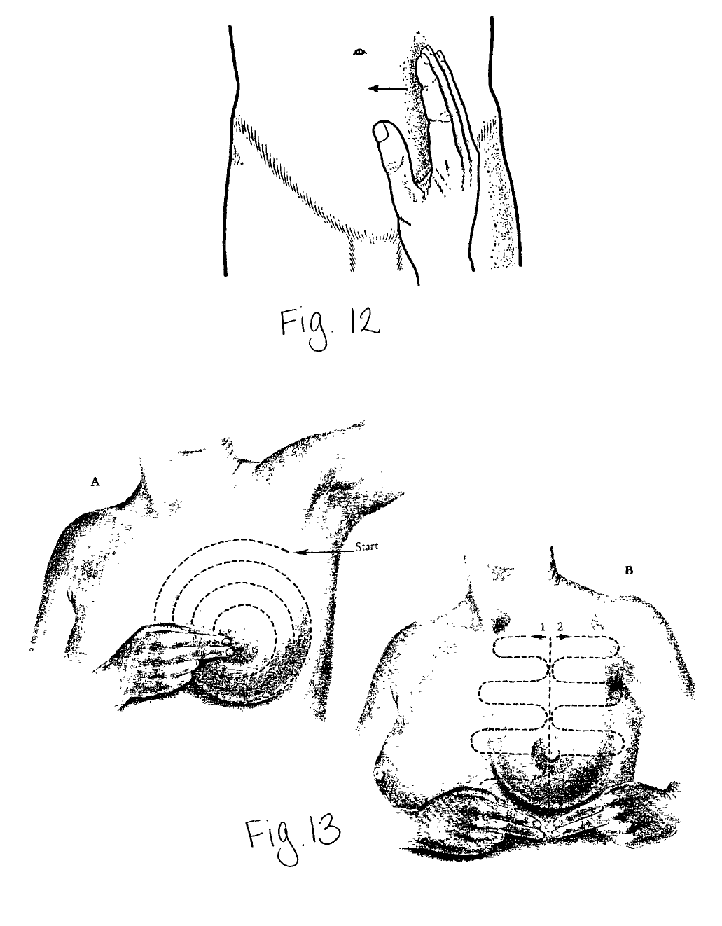

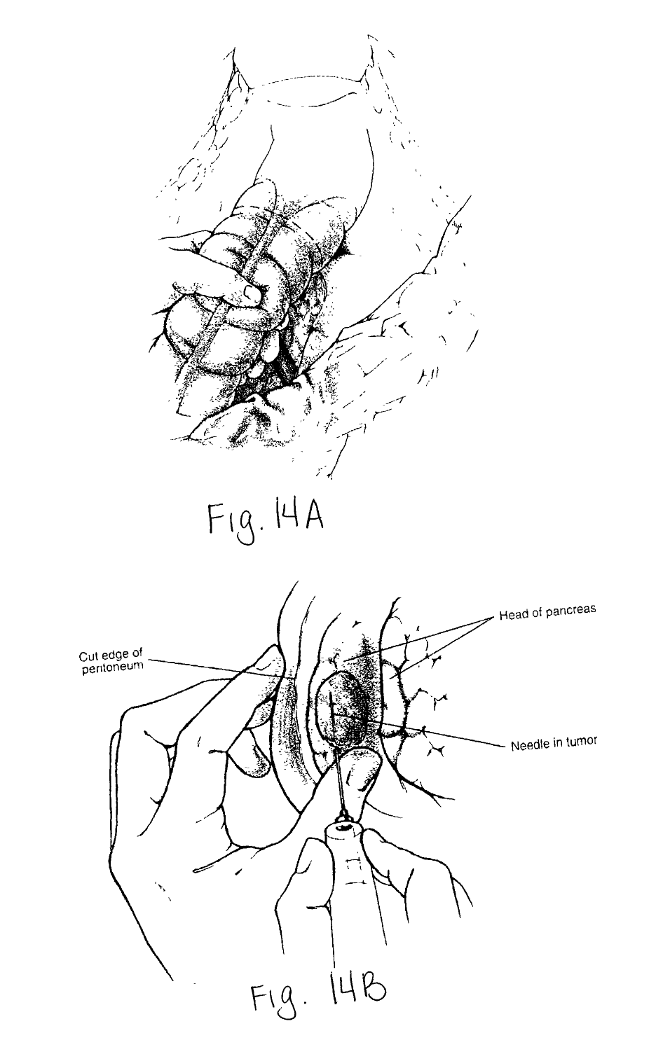

The present invention may be used to train students to perform any type of exam or procedure performed manually on a body or organ surface. FIG. 12 illustrates an abdominal examination. By combining the palpatory findings of the abdomen, the patient's response to palpation and laboratory and radiologic findings, clinicians are expected to make life saving decisions regarding treatment options. Breast exams are similar to other soft tissue exams and abdominal exams in that they are performed manually on a body surface and rely on the practitioner's ability to feel and recognize particular surfaces, as well as tissues and organs beneath the surface that are not directly visible to the examiner. FIG. 13 illustrates two methods of breast palpation. Important examination qualities include surface area covered and experience in discriminating between cystic and solid lesions and normal breast tissue. Intra-abdominal examinations require direct manual contact with organ surfaces for a similar purpose; examining and recognizing surfaces and deeper tissues to aid in diagnosis. The teaching system of the present invention provides for a variety of surface abdominal, intra-abdominal and soft tissue exams based on simulated patients with a range of normal clinical findings and simulated patients with a variety of pathological findings. For example, students are trained to perform abdominal exams on normal and pathological patients and breast exams for locating cancerous lesions with a variety of clinical presentations.

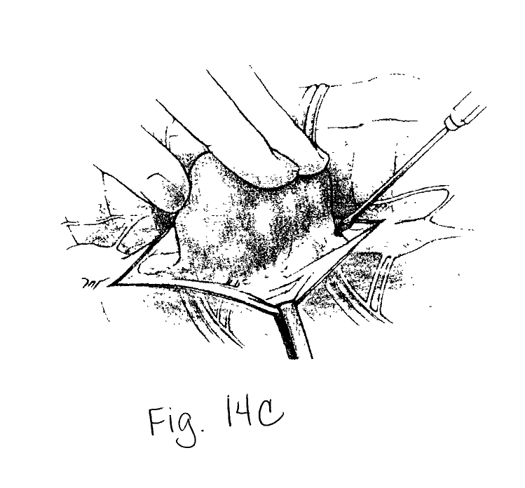

Many surgical procedures have a component that must be performed manually on or inside an anatomical space and involving an organ or body surface, and any such procedure can be taught using the present invention. For example, abdominal surgery often requires intraoperative assessment of internal abdominal organs which the surgeon feels with his or her hands organs or internal body surfaces such as the spleen or posterior abdominal wall. FIGS. 14a-c illustrate various surgical procedures requiring intra-abdominal palpation including, palpation of a colonic tumor to confirm location of the lesion prior to colon resection; palpation of a pancreatic mass while preparing for a transduodenal biopsy; and palpation of a neurogenic tumor arising in the posterior abdominal wall. Retro-peritoneal tumors, tumors that lie deep to or within the posterior abdominal wall muscles, require a surgeon to directly palpate the location and extent of the tumor to know the difference between the tumor and normal tissue. By hand, the surgeon can feel where the solid tumor ends and a major blood vessel begins for example. Palpatory discrimination is a vital tool for surgeons performing surgical procedures. In cases where tumors or abnormalities can not be palpated special radiologic devices or procedures must be used to assist the surgeon such as needle localization of a breast tumor or placement of ureteral stents so the ureter can be palpated and protected from unwanted injury during abdominal procedures.

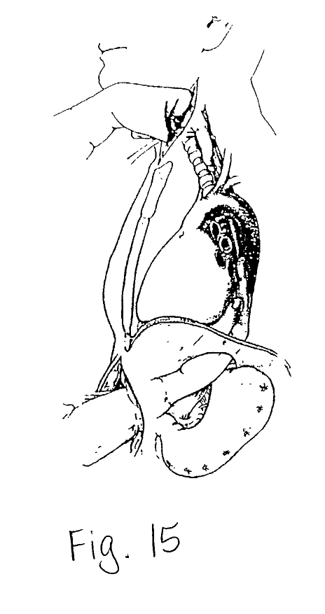

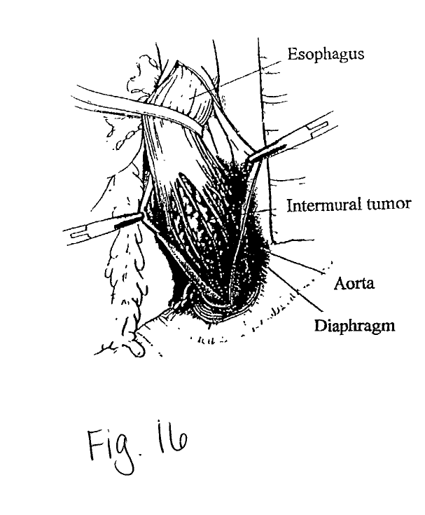

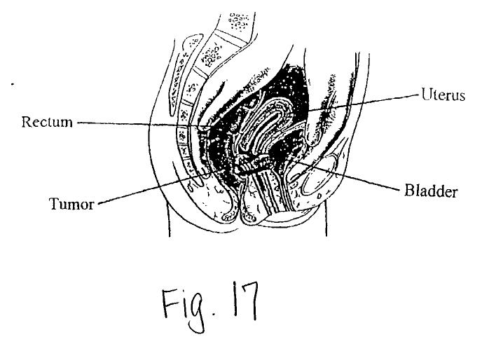

Prostatectomies (prostate removal), which entail manual removal of the prostate, are notoriously difficult to teach. The procedure cannot be seen by the student, and only a few fingers can be inserted, preventing the student from seeing or feeling the performance of the instructor. Dissections around the trachea and esophagus require the surgeon to insert his or her fingers around the trachea and esophagus to obtain information about the hidden region. FIG. 15 illustrates one of the maneuvers performed during a transhiatal esophagectomy, in which a portion of the esophagus is dissected bimanually. As shown in the figure, the surgeon inserts one hand through the hiatus of the diaphragm and the other through a cervical incision in the neck, taking extreme care to prevent tearing of the membranous portion of the trachea. The bimanual dissection continues until the fingers of the two hands meet. FIG. 16 illustrates a procedure for removing an intramural esophageal tumor. In many cases, the tumor is separated from the surrounding tissue and removed by hand, requiring careful attention of the surgeon not to injure the mucosa. FIG. 17 illustrates a pelvic extenteration (treatment for various gynecologic cancers), in part, being performed bimanually. All of these surgical procedures (or parts of the procedures) are done by hand and require the student to learn the anatomy by feel. They are therefore particularly good candidates for applications of the present invention.

It will be clear to one skilled in the art that the above embodiments may be altered in many ways without departing from the scope of the invention. Not only does the present invention allow for the development of standards regarding examination techniques by serving as a tool that can measure and define human performance during certain medical examinations and procedures, this systems also serves as a teaching and assessment tool. In addition to teaching and assessing technical, hands-on skills, this system may be used to enhance and assess cognitive clinical knowledge by tracking the clinician's decision making abilities as it relates to the physical exam findings. For example, the feedback presentation unit may have different modules for interacting with students of different levels. The emergency situation simulated in the video signal may be enhanced by a process in which the computer telephones the student at an unexpected time. In response to the telephone call, the student must perform an exam, evaluate the patient, and make further recommendations. Accordingly, the scope of the invention should be determined by the following claims and their legal equivalents.

What is claimed is:

1. A system for training and measuring student performance for medical exams using at least one hand of said student for direct human contact with a body or an organ surface, said system comprising:
a) an anatomical simulator having a simulated body or organ surface wherein at least part of said simulated body or organ surface is directly accessible by manual contact of said at least hand of said student;
b) one or more sensors in said anatomical simulator for generating signals in response to said manual contact with said simulated body or organ surface, wherein said contact represents said medical exam;
c) a feedback presentation unit in communication with said signal from said one or more sensors for providing feedback to said student so as to train said student to perform said medical exam; and
d) a software means to assess said student performance using said signals from said one or more sensors.

2. The system as set forth in claim 1, wherein said body or organ surface comprises one or more tissue layers and at least part of one of said one or more tissue layers is not visible to said student.

3. The system as set forth in claim 1, wherein said one or more sensors are force sensing resistors and said signals represent force(s) on said body or organ surface.

4. The system as set forth in claim 1, wherein said one or more sensors are force feedback sensors and said signals represent force(s) on said body or organ surface.

5. The system as set forth in claim 1, wherein said one or more sensors are motion detectors and said signals represent action(s) in reference to said body or organ surface.

6. The system as set forth in claim 1, wherein said simulated body or organ surface comprises virtual reality or miniature robotic means to mimic medical scenarios.

7. The system as set forth in claim 1, wherein said anatomical simulator and said feedback presentation unit are adjustable to provide feedback for one of a plurality of different medical exams.

8. The system as set forth in claim 1, wherein said medical exam is a pelvic exam and said anatomical simulator comprises the lower torso of a human female.

9. The system as set forth in claim 1, wherein said medical exam is an abdominal exam and said simulator comprises the lower torso of a human subject.

10. The system as set forth in claim 1, wherein said medical exam is a rectal exam and said anatomical simulator comprises the lower torso of a human.

11. The system as set forth in claim 1, wherein said medical exam is a breast exam and said anatomical simulator comprises the upper torso of a human.

12. The system as set forth in claim 1, wherein said medical exam is a soft-tissue exam and said anatomical simulator comprises simulated soft tissue.

13. The system as set forth in claim 1, wherein said medical exam is direct examination of an intra-abdominal organ and said anatomical simulator comprises a simulated intra-abdominal organ.

14. The system as set forth in claim 1, wherein said medical exam comprises a surgical procedure.

15. The system as set forth in claim 10, wherein said surgical procedure is selected from the group consisting of abdominal, pelvic and thoracic surgery.

16. The system as set forth in claim 10, wherein said surgical procedure is selected from the group consisting of prostatectomy, pelvic extenteration, and transhiatal esophagectomy.

17. The system as set forth in claim 1, wherein said anatomical simulator comprises a plurality of removable anatomical parts having surfaces, and wherein said surface of said simulated body or organ comprises said surfaces of said removable anatomical parts.

18. The system as set forth in claim 13, wherein at least one of said plurality of removable anatomical parts represents a diseased condition, and said medical exam is correlated with said diseased condition.

19. The system as set forth in claim 1, wherein said anatomical simulator comprises a plurality of removable tissue layers wherein any combination of said layers represents said simulated body or organ surface.

20. The system as set forth in claim 15, wherein at least one of said plurality of removable tissue layers represents a diseased condition, and said medical exam is correlated with said diseased condition.

21. The system as set forth in claim 1, wherein said medical exam comprises a set of predetermined steps and said feedback comprises an indication of completion of said set of predetermined steps.

22. The system as set forth in claim 1, wherein said feedback presentation unit comprises:
a) a computer having a processor, a display means, and a memory; and
b) converting means for converting said signals to inputs for said computer;
wherein said memory stores computer readable code executable by said processor to process said inputs to provide said feedback.

23. The system as set forth in claim 18, wherein said feedback comprises a graphical display on said display means.

24. The system as set forth in claim 18, wherein said feedback comprises a rating for said exam, and wherein said computer readable code instructs said computer to compare said inputs with a reference exam to derive said rating.

25. The system as set forth in claim 18, wherein said feedback comprises instruction to said student and said computer readable code instructs said computer to compare said inputs with a reference exam during said exam to determine said instruction.

26. The system as set forth in claim 18, wherein said computer further comprises storage means for storing video signals and associated audio and olfactory signals representing a realistic patient environment, and said computer readable code controls presentation of said video signals and said associated audio and olfactory signals.

27. The system as set forth in claim 1, wherein said feedback presentation unit comprises a liquid crystal display.

28. The system as set forth in claim 1, wherein said feedback presentation unit is an analog display unit.

29. The system as set forth in claim 1, wherein said feedback presentation unit is a three dimensional virtual display enhanced with haptic feedback and said presentation method is a virtual reality presentation.

30. The system as set forth in claim 1, wherein said simulation system comprises virtual reality means and haptic feedback means.

31. The system as set forth in claim 1, wherein said software means comprises stored data points from a collection of pre-selected clinician exams.

32. The system as set forth in claim 1, further comprising developing and storing a collection of reference exams from pre-selected clinician groups.

33. The system as set forth in claim 1, wherein said software means comprises reference exams and said reference exams are compared to said user's performance.

34. A method for training and measuring student performance during medical exams involving the use of at least one hand of said student for direct human contact with a body or organ surface, said method comprising:
a) receiving signals from one or more sensors in or on a simulated body or organ surface of an anatomical simulator wherein said simulated body or organ surface is directly accessible to direct human contact, and said signals are generated in response to a manual contact of at least one hand of said student with said simulated body or organ surface; and
b) providing feedback to said student, wherein said feedback is in part derived from said signals so as to train said student to perform said medical exam.

35. The method as set forth in claim 30, further comprising providing a software means to assess said student performance using said signals from one or more sensors.

36. The method as set forth in claim 30, wherein said simulated body or organ surface comprises one or more tissue layers and said at least part of one of said one or more tissue layers is not visible to said student.

37. The method as set forth in claim 30, further comprising comparing said signals with a reference exam to derive said feedback.

38. The method as set forth in claim 31, wherein said reference exam corresponds to a manually detectable condition in said simulated body or organ surface.

39. The method as set forth in claim 31, wherein said reference exam corresponds to a pathological condition of said simulated body or organ surface.

40. The method as set forth in claim 30, further comprising analyzing said signals to determine whether a set of predetermined steps has been completed by said student, wherein said feedback comprises an indication of completion of said set of predetermined steps.

41. The method as set forth in claim 30 wherein the method is implemented in a computer.

42. The method as set forth in claim 35, wherein said computer comprises a display means and said feedback comprises a graphical display on said display means.

43. The method as set forth in claim 30, wherein providing said feedback comprises providing a rating for said exam.

44. The method as set forth in claim 30, further comprising providing instruction to said student.

45. The method as set forth in claim 42, wherein said instruction is determined in part from said received signals.

46. The method as set forth in claim 30, further comprising presenting video signals, audio signals and olfactory signals to said student, wherein said video signals and said audio and olfactory signals represent a realistic patient environment.

47. The method as set forth in claim 30, wherein said feedback is a virtual reality presentation.
